(19) United States
(12) Patent Application Publication
(10) Pub. No.: US 2026/0264709 A1
(43) Pub. Date: Sep. 10, 2026

(54) Device and Method for Operating a Vehicle

(71) Applicant: Bayerische Motoren Werke Aktiengesellschaft, Muenchen (DE)

(72) Inventors: Simone Camberg, Muenchen (DE); Thomas Ewender, Bad Aibling (DE); Johannes Feldmaier, Ebersberg (DE)

(21) Appl. No.: 19/165,315

(22) PCT Filed: Oct. 11, 2023
(86) PCT No.: PCT/EP2023/078232

§ 371 Date: Sep. 15, 2025

(30) Foreign Application Priority Data
Mar. 20, 2023 (DE) 10 2023 106 843.1

(51) Int. Cl. B60W 50/14; G06V 20/59; G06V 40/10

(52) U.S. Cl. CPC B60W 50/14; G06V 20/597; G06V 40/10; B60W 2420/403; B60W 2540/221

(57) ABSTRACT

A device includes a unit of the vehicle that captures an item of driver information relating to a vehicle driver, and generates driver data therefrom. The device also includes a unit that captures an external warning signal that has been output in an environment of the vehicle, and generates warning-signal data corresponding thereto. The device further includes a control unit that determines, based at least in part on the driver data, causes an output unit to output an internal warning signal that corresponds in its warning function to the external warning signal and is perceptible by at least one sense of the vehicle driver, if the control unit has determined that the vehicle driver is temporarily restricted in the auditory capability.

The present application is the U.S. national phase of PCT Application PCT/EP2023/078232 filed on Oct. 11, 2023, which claims priority of German patent application No. 10 2023 106 843.1 filed on Mar. 20, 2023, the entire contents of which are incorporated herein by reference.

### TECHNICAL FIELD

The disclosure relates to generally to the field of vehicles, and more specifically, to operating a vehicle.

### BACKGROUND

A method for operating a motor vehicle is known from DE 10 2015 015 130 A1. In this method, an ambient noise is classified according to urgency, and is output, in accordance with the urgency, to a driver of the motor vehicle who is wearing headphones.

DE 11 2015 006 772 T5 discloses a method for noise-direction detection in a vehicle. In this method, the direction of a noise external to the vehicle is detected, in order to convert the noise into a haptic signal for the vehicle driver.

DE 2012 016 819 A1 discloses a method for assisting a driver of a motor vehicle. In this method, a noise is captured. A warning is output to the driver when a hazard-indicating noise has been captured.

Driving a vehicle requires concentration from a vehicle driver on the environment of the vehicle, in particular on the traffic situation surrounding the vehicle. In particular, the vehicle driver has to be able to perceive warning signals in the environment of the vehicle, in order to be able to react to these signals appropriately. However, more and more vehicle drivers are wearing headphones or other devices while driving, which may restrict the ability of the vehicle driver to hear. In-ear headphones and headphones with active noise-cancelling, in particular, make it difficult for the vehicle driver to perceive acoustic warning signals—for instance, horns and sirens of emergency vehicles. The very noise of good insulation modern vehicles additionally restricts the acoustic information that the vehicle driver is able to perceive.

There is a need, therefore, for a device and a method for operating a vehicle that enhance the safety of the vehicle in traffic that addresses the issues discussed above.

### SUMMARY

The above-stated need, as well as others, are addressed by at least one embodiment described herein.

A first embodiment of a device for operating a vehicle includes an occupant-capture unit of the vehicle, configured to capture at least one item of driver information relating to a driver of the vehicle and to generate driver data corresponding to the item of driver information, and an environment-capture unit of the vehicle, configured to capture an external warning signal that has been output in the environment of the vehicle and to generate warning-signal data corresponding to the warning signal. The device includes, in addition, an output unit configured to output an internal warning signal to the vehicle driver. The device further includes a control unit configured to ascertain, on the basis of the driver data, whether the vehicle driver is temporarily restricted in his/her auditory capability, and to control, on the basis of the warning-signal data, the output unit for outputting the internal warning signal in such a manner that the internal warning signal corresponds in its warning function to the external warning signal and is perceptible by at least one sense of the vehicle driver when the control unit has ascertained that the vehicle driver is temporarily restricted in his/her auditory capability.

The external warning signal is, in particular, an acoustic warning signal. The output unit has, in particular, been designed to output the internal warning signal as a visual, auditory and/or haptic warning signal. For this purpose, the output unit includes, in particular, at least one of the following functional units:

loudspeaker, an indicating element, in particular a display screen facing toward the vehicle driver, a head-up display, a central information display or a graphical instrument cluster, an illuminated indicator, for instance a signal lamp or a luminous area in the cockpit of the vehicle, in particular on a steering wheel of the vehicle, and a haptic output element, for instance a vibration function of a seat of the vehicle.

The device can firstly ascertain whether the vehicle driver is temporarily restricted in his/her auditory capability—that is to say, whether the vehicle driver is, for the time being, restricted in his/her ability to perceive acoustic warning signals, for instance as a result of wearing headphones. In order to ascertain whether the vehicle driver is temporarily restricted in his/her auditory capability, the control unit uses the driver data—that is to say, the control unit draws upon the capturable driver information. By virtue of the fact that the ascertainment is based upon capturable information, this ascertainment can be undertaken particularly reliably, and the control unit can counteract the auditory restriction of the vehicle driver in targeted manner. Concrete examples of the driver information are described in the following in connection with embodiments of the invention. If the control unit establishes an auditory restriction of the vehicle driver, the external warning signal is output to the vehicle driver as the internal warning signal in such a manner that the driver is able to perceive the internal warning signal despite his/her auditory restriction. For instance, the external acoustic warning signal can be converted into a visual warning signal which is indicated to the vehicle driver as the internal warning signal. By virtue of the targeted counteracting of the auditory restriction of the vehicle driver, the vehicle driver is able to perceive and react to acoustic warning signals in the environment of the vehicle. By this means, the proposed device contributes significantly to enhancing the safety of the vehicle in traffic.

In at least one embodiment, the occupant-capture unit includes an image-capture unit of the vehicle, configured to capture at least one driver image including a representation of the vehicle driver as the driver information, and to generate driver-image data corresponding to the driver image. The driver data include the driver-image data, and the control unit has been designed to ascertain, taking the driver-image data into account, whether the vehicle driver is temporarily restricted in his/her auditory capability. The image-capture unit of the occupant-capture unit is, in particular, an interior camera of the vehicle. The image-capture unit has been designed, in particular, to capture a two-dimensional image of the vehicle interior. Furthermore, for the purpose of generating a sequence of driver images as the driver information, the image-capture unit may have been designed to capture several temporally successive driver images which each include a representation of the vehicle driver. In such an embodiment, the driver-image data correspond to the sequence of driver images. The image-capture unit captures, in particular, light within the optical spectrum and/or within the infrared spectrum. The capture of light within the infrared spectrum has the additional advantage that the occupant-capture unit can capture the driver image or the sequence of driver images even in poor lighting conditions, for instance at night. As an alternative to an optical camera, the image-capture unit may also comprise a time-of-flight camera, a radar system or a lidar system which generates a three-dimensional image of the vehicle interior, in particular in the form of a point cloud. From the driver-image data generated by the image-capture unit, the control unit can extract a series of features of the vehicle driver, from which it can be reliably ascertained whether the vehicle driver is temporarily restricted in his/her auditory capability. Concrete examples of these features are described in the following with reference to further embodiments of the invention.

In some embodiments, the control unit is designed to ascertain, on the basis of the driver-image data, whether the vehicle driver is wearing headphones and/or other noise-suppressing devices, and to ascertain that the vehicle driver is temporarily restricted in his/her auditory capability if the control unit has ascertained that the vehicle driver is wearing headphones or other noise-suppressing devices. By “other noise-suppressing devices”, helmets that at least partly cover the ears of the vehicle driver, earplugs and similar devices are meant, in particular. Headphones and other noise-suppressing devices can be easily and reliably recognized in the driver image, for instance with the aid of a suitable machine-learning method. Consequently the control unit can reliably determine, by reference to the driver-image data, whether the vehicle driver is temporarily restricted in his/her auditory capability as a result of wearing headphones or other noise-suppressing devices.

In some implementations, the control unit is configured to ascertain whether the headphones that the vehicle driver is wearing are connected to an entertainment system of the vehicle, and to control the output unit in such a manner that the internal warning signal is output via the headphones that the vehicle driver is wearing if the control unit has ascertained that these headphones are connected to the entertainment system of the vehicle. A connection between the headphones and the entertainment system of the vehicle is made, in particular, via a wireless interface, for instance Bluetooth®, or via a wired interface, such as a jack plug for example. In this embodiment, the control unit ascertains whether the headphones that the control unit has recognized in the driver image are connected to the entertainment system of the vehicle. If the headphones are connected to the entertainment system of the vehicle, they can be utilized advantageously for the output of the internal warning signal. For instance, the output unit can activate the entertainment system of the vehicle for outputting the internal warning signal through the headphones. In this process, a media playback by the entertainment system can be briefly interrupted, or the internal warning signal is mixed into the media playback. By virtue of the output of the internal warning signal via the headphones of the vehicle driver, it is ensured that the vehicle driver perceives the internal warning signal, as a result of which the safety in traffic is further enhanced.

In some embodiments, the control unit includes at least one memory element and has been designed to store a profile individually assigned to the vehicle driver in the memory element, and to read said profile from the memory element. The profile assigned to the vehicle driver may include the information as to whether the vehicle driver wears a hearing-aid. The control unit may furthermore have been designed to ascertain, on the basis of the driver-image data, whether the vehicle driver is wearing a hearing-aid at the present time, and to ascertain that the vehicle driver is temporarily restricted in his/her auditory capability if the vehicle driver is not wearing his/her hearing-aid. The term “hearing-aid” is understood to mean, for instance, a hearing appliance. If a person who normally wears a hearing-aid is not wearing this hearing-aid, this person is restricted in his/her auditory capabilities. Therefore from the fact that the vehicle driver is not wearing his/her hearing-aid it can be inferred very reliably that the vehicle driver is temporarily restricted in his/her auditory capability.

In some embodiments, the occupant-capture unit is configured to ascertain a loudness at which media data are being played back in the vehicle interior as the driver information, and to generate loudness data corresponding to the loudness. The driver data include the loudness data, and the control unit has been designed to ascertain, taking the loudness data into account, whether the vehicle driver is temporarily restricted in his/her auditory capability. For instance, loud music which is being played back in the vehicle interior may easily drown out noises outside the vehicle. For instance, from the fact that the loudness in the vehicle interior has exceeded a predetermined level, it can be reliably inferred that the vehicle driver is temporarily restricted in his/her auditory capability. Consequently the ascertainment of whether the vehicle driver is temporarily restricted in his/her auditory capability can be undertaken very reliably, taking the loudness data into account.

In at least one implementation, the occupant-capture unit is configured to capture whether media data are being played back to the vehicle driver by an appliance that has been brought into the vehicle interior, and to generate appliance data corresponding to this ascertainment. The driver data include the appliance data, and the control unit has been designed to ascertain, taking the appliance data into account, whether the vehicle driver is temporarily restricted in his/her auditory capability. By the term “appliances” in this document, smart devices such as, for instance, smartphones, tablet computers, handheld game consoles and similar portable terminals are meant, in particular, that are suitable for media playback. Furthermore, by the term “appliances”, devices for media playback, such as, for instance, wearable loudspeakers or other wearable audio appliances, are understood. For instance, the occupant-capture unit may have been designed to capture whether a smart device is connected to the control unit of the vehicle, for example via a wireless interface, for instance WLAN, Bluetooth® or near-field communication (NFC), or via a wired interface, for instance Ethernet or USB. With the aid of this connection, it can then be ascertained whether the smart device is playing back media data at the present time. In particular, an application may have been installed on the smart device that makes the connection between the smart device and the control unit of the vehicle possible and/or that provides the information to the control unit of the vehicle as to whether the smart device is playing back media at the present time. The communication between the smart device and the control unit can also be undertaken via a processing unit (back-end) arranged remotely from the vehicle. The communication between the smart device and the remote processing unit can be undertaken, for instance, via a mobile radio network and/or a network for remote data transmission, for instance the Internet. The presence of an appliance for media playback can furthermore be e ascertained by the control unit by reference to the driver-image data. For instance, the control unit can recognize a wearable loudspeaker in the driver image and can ascertain, by reference to active LEDs of the wearable loudspeaker, that this loudspeaker is currently playing back media data. Particularly advantageously in this embodiment, the control unit can additionally ascertain, for instance by reference to the driver-image data, whether the vehicle driver is wearing headphones. If media data are being played back to the vehicle driver by the appliance, for instance if the vehicle driver is listening to music or to a podcast, the vehicle driver is restricted in his/her ability to perceive the external warning signal. From the fact that media data are being played back to the vehicle driver by the smart device, it can consequently be inferred very reliably that the vehicle driver is temporarily restricted in his/her auditory capability.

In some embodiments, the output unit is configured to output the internal warning signal via the smart device, in particular via headphones connected to the smart device. For this purpose, the media playback by the smart device can be interrupted, or the internal warning signal can be mixed into the media playback. The smart device can also be activated in such a manner that the output of the internal warning signal is prioritized over other outputs of the smart device, in particular over audio outputs. Alternatively or additionally, the internal warning signal can be output by the smart device in the form of a push notification. In order to activate the smart device, in particular the connection between the smart device and the control unit of the vehicle can be used. This connection can be made, in particular, via the processing unit (back-end) arranged remotely from the vehicle. The output of the internal warning signal via the smart device, or via the headphones that the vehicle driver is wearing, has the advantages described above.

In some implementations, the control unit has been configured to ascertain, on the basis of the driver data, whether the vehicle driver is reacting to the external warning signal, and to ascertain that the vehicle driver is temporarily restricted in his/her auditory capability if the control unit has ascertained that the vehicle driver is not reacting to the external warning signal. Acoustic warning signals trigger an often unconscious reaction in people—for instance, turning the head in the direction of the warning signal, checking a mirror of the vehicle, or suddenly opening the eyes wide. This unconscious reaction can be captured, for instance in the driver image. Therefore the control unit is configured, in particular, to ascertain, on the basis of the driver-image data, whether the vehicle driver is reacting to the external warning signal. The ascertainment of whether the vehicle driver is reacting to the external warning signal can be ascertained particularly reliably from the sequence of driver images. A further reaction of the vehicle driver to the external warning signal may be the executing of a particular driving maneuver, for instance applying the brake, pulling over to the left or right.

Therefore the occupant-capture unit may also have been designed to capture an item of information relating to the driving style of the vehicle driver as the driver information. In particular, the occupant-capture unit may also have been designed to capture one of the following items of information: a speed of the vehicle, an acceleration of the vehicle, a retardation of the vehicle, or a change of direction of the vehicle. In such an embodiment, the control unit may have been designed to ascertain a driving maneuver on the basis of the driver data, and to ascertain, on the basis of on the driving maneuver, whether the vehicle driver is reacting to the external warning signal. If a reaction of the vehicle driver to the external warning signal fails to occur, it can be reliably inferred that the vehicle driver has not perceived the external warning signal—that is to say, the vehicle driver is temporarily restricted in his/her auditory capability.

In some embodiments, the environment-capture unit includes a microphone configured to capture at least one audio recording of the environment of the vehicle, and to generate audio data corresponding to the audio recording. The warning-signal data include the audio data, and the control unit has been designed to control the output unit for outputting the internal warning signal on the basis of the audio data in such a manner that the internal warning signal corresponds in its warning function to the external warning signal. The microphone is preferably an exterior microphone of the vehicle. With the aid of the microphone, acoustic warning signals in the environment of the vehicle can be captured. These warning signals can then be extracted from the audio data by the control unit and can be classified, for instance with the aid of method. On the basis of the a machine-learning classification, the internal warning signal can then be generated. Alternatively, the internal warning signal can be generated directly from the audio data, for instance by simple playback of the audio data—that is to say, of the recorded external warning signal—as the internal warning signal.

In some embodiments, the environment-capture unit includes an image-capture unit of the vehicle, configured to capture at least one exterior image including a representation of the environment of the vehicle, and to corresponding to the generate exterior-image data exterior image. The warning-signal data include the exterior-image data, and the control unit has been designed to control the output unit for outputting the internal warning signal on the basis of the exterior-image data in such a manner that the internal warning signal corresponds in its warning function to the external warning signal. The image-capture unit of the environment-capture unit is, in particular, an exterior camera of the vehicle, for instance an exterior camera of a parking-assistance system. The image-capture unit has, in particular, been designed to capture a two-dimensional image of the environment of the vehicle. The image-capture unit captures, in particular, light within the optical spectrum and/or within the infrared spectrum. The capture of light within the infrared spectrum has the advantages described above. Some warning signals—for instance, the blue light of an emergency vehicle—are visual warning signals. Visual warning signals often accompany acoustic warning signals—in the aforementioned example, the siren of the emergency vehicle. The capture of the external warning signal can consequently be assisted by the image-capture unit of the environment-capture unit and can therefore be undertaken more reliably.

In some embodiments, the environment-capture unit has been designed to capture a direction from which the external warning signal is being output, and to generate directional data corresponding to the direction. The warning-signal data include the directional data, and the control unit has been designed to control the output unit for outputting the internal warning signal in such a manner that the warning signal is output at a location within the vehicle interior that corresponds to the direction from which the external warning signal is being output. The capture of the direction of the external warning signal can be undertaken, in particular, by using the exterior-image data. If, for instance, the direction of a siren of an emergency vehicle is being determined, the direction of the blue light can be determined additionally, since a determination solely by reference to the acoustic component of the warning signal would be less reliable, especially in reverberating environments such as urban canyons, for instance. By outputting the warning signal at a location within the vehicle interior that corresponds to the direction of the external warning signal, the attention of the vehicle driver is directed toward the source of the warning signal. By this means, the safety in traffic is enhanced still further.

The disclosure further relates to a method for operating a vehicle. In this method, at least one item of driver information relating to a driver of the vehicle is captured. Driver data corresponding to the driver information are generated. An external warning signal that has been output in the environment of the vehicle is captured, and warning-signal data corresponding to the warning signal are generated. On the basis of the driver data, it is ascertained whether the vehicle driver is temporarily restricted in his/her auditory capability. Furthermore, on the basis of the warning-signal data an internal warning signal is output to the vehicle driver in such a manner that the internal warning signal corresponds in its warning function to the external warning signal and is perceptible by at least one sense of the vehicle driver if it has been ascertained that the vehicle driver is temporarily restricted in his/her auditory capability.

The method has the same advantages as the claimed device. In particular, the method can be developed with the features of the dependent claims directed toward the device. Furthermore, the device described above can be developed with the features that have been described in connection with the method.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective schematic representation of a cockpit of a vehicle; and

FIG. 2 shows a flowchart of the method for operating the vehicle.

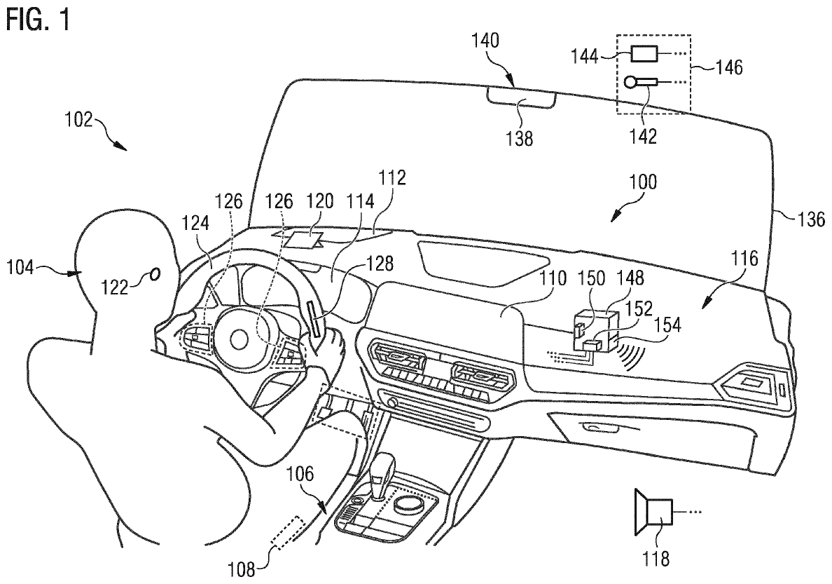

FIG. 1 shows a perspective schematic representation of a cockpit 100 of a vehicle 102.

A vehicle driver 104 is sitting on a driver's seat 106 of the vehicle 102. The driver's seat 106 may feature a vibration function 108 and may consequently constitute a functional unit of an output unit of the vehicle 102, configured to output information to the vehicle driver 104. The cockpit 100 includes, in addition, a central information display (CID) 110, a head-up display 112 and a graphical instrument cluster 114, which are arranged on a dashboard 116 of the vehicle 102. The aforementioned indicating elements 110, 112, 114 each likewise constitute functional units of the output unit. At least one loudspeaker 118 of an entertainment system of the vehicle is likewise arranged in the cockpit 100. The loudspeaker 118 also constitutes a functional unit of the output unit.

On a driver's side of the dashboard 116 a smart device 120 is arranged which was brought into the vehicle 102 by the vehicle driver 104. Purely by way of example, the smart device 120 is a smartphone. The smart device 120 may have been designed to control the entertainment system of the vehicle 102, for instance to make media data available that are played back by the entertainment system. Purely by way of example, the smart device 120 is connected to headphones 122 which the vehicle driver 104 is wearing and via which the media data can be played back.

The cockpit 100 includes, in addition, a steering wheel 124 which includes two clusters 126 of control elements and signal lamps. The signal lamps of the steering wheel each constitute a functional unit of the output unit. The steering wheel likewise features, in addition, a vibration function 128 which likewise constitutes a functional unit of the output unit. The cockpit 100 further includes a gear selector switch 130, a set of pedals 132 and also an input unit 134 with a rotary wheel and with a push-button function and/or with a touch input field. This input unit 134 is also designated as an Ergo Commander.

An interior camera 138 is arranged in the upper region of a windshield 136 of the vehicle 102. The interior camera 138 has been arranged and aligned in such a manner that the interior camera 138 is able to capture at least one driver image including a representation of the vehicle driver 104. In particular, the interior camera 138 has been designed to capture a sequence of driver images consisting of several temporally successive driver images which each include a representation of the vehicle driver 104. The interior camera 138 has furthermore been designed to generate driver-image data corresponding to the driver image or to the sequence of driver images. The interior camera 138 is a functional unit of an occupant-capture unit 140 for capturing driver information relating to the vehicle driver 104. Accordingly, the driver-image data constitute a part of driver data that correspond to the driver information. The occupant-capture unit 140 can capture, besides the driver image, further driver information—for instance, a loudness at which media data are being played back in the vehicle interior. For this purpose, the occupant—capture unit 140 may exhibit further functional units—in particular, sensors—which measure the loudness in the vehicle interior, or the occupant-capture unit 140 may have been designed to receive this information from the entertainment system of the vehicle 102. Further examples of driver information are stated in the following.

A microphone 142 and an exterior camera 144 of the vehicle 102 are shown purely schematically above the windscreen 136.

The microphone 142 has been designed to capture at least one audio recording of the environment of the vehicle 102, and to generate audio data corresponding to the audio recording. The audio recording is, in particular, the audio recording of an acoustic component of an external warning signal that is being output from a source in the environment of the vehicle 102. In particular, the microphone 142 has been designed to capture a direction of the source of the warning signal relative to the vehicle 102, and to generate directional data corresponding to the direction. The exterior camera 144 is, for instance, a parking camera, and has been arranged and aligned to capture at least one exterior image including a representation of the environment of the vehicle 102, and to generate exterior-image data corresponding to the exterior image. The representation of the environment includes, in particular, a visual component of the external warning signal. In particular, the exterior camera 144 has been designed to capture a sequence of exterior images consisting of several temporally successive exterior images which each include a representation of the environment of the vehicle 102. The exterior camera 144 may also have been designed to capture the direction of the source of the warning signal relative to the vehicle 102, and to generate directional data corresponding to the direction. The microphone 142 and the exterior camera 144 are functional units of an environment-capture unit 146 for capturing the external warning signal. Accordingly, the audio data, the exterior-image data and the directional data constitute a part of warning-signal data that are generated and made available by the environment-capture unit 146.

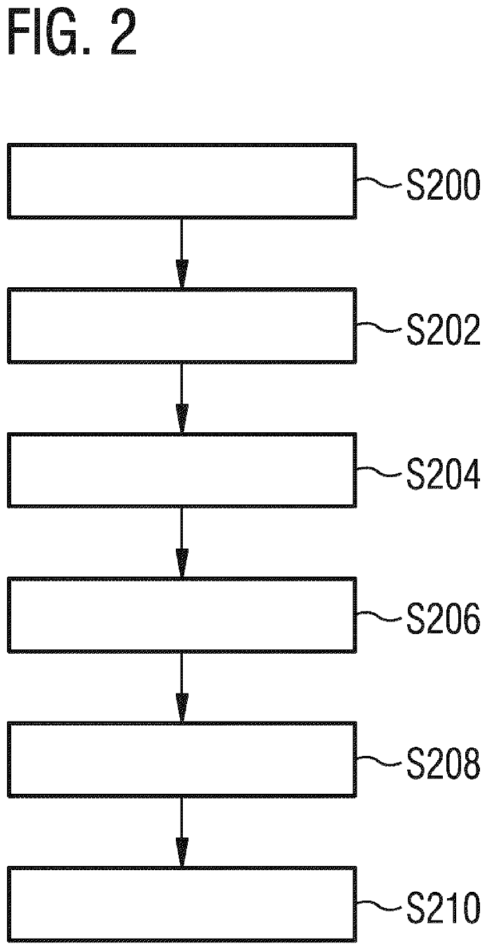

A control unit 148 of the vehicle 102 has a memory area, data outputs 150 and data inputs 152, which serve for connecting to the aforementioned and further functional units of the vehicle 102. The control unit 148 has, in addition, a communications interface 154 configured to provide a connection to the smart device 120. Via this communications interface 154, the smart device 120 can, for instance, be connected to the entertainment system of the vehicle 102 for a media playback. In particular, the control unit 148 can ascertain via the communications interface 154 whether the smart device 120 is playing back media data to the vehicle driver 104 at the present time. For instance, an application on the smart device 120 can provide this information. The control unit 148 can forward the information as to whether the smart device 120 is playing back media data at the present time to the occupant-capture unit 140 as an item of driver information. The control unit 148 has furthermore been designed to carry out a method in which the control unit 148 receives the driver data from the occupant-capture unit 140 and the warning-signal data from the environment-capture unit 146, and processes said data. In this method, the control unit 148 ascertains, on the basis of the driver data, whether the vehicle driver 104 is temporarily restricted in his/her auditory capability. If the control unit 148 has ascertained that the vehicle driver 104 is temporarily restricted in his/her auditory capability, the control unit t 148 then activates the output unit on the basis of the warning-signal data in such a manner that the output unit outputs an internal warning signal to the vehicle driver 104 in such a manner that the internal warning signal corresponds in its warning function to the external warning signal and is perceptible by at least one sense of the vehicle driver 104. The method is described in more detail in the following with reference to FIG. 2.

FIG. 2 shows a flowchart of the method for operating the vehicle 102. The method is started in step S200. In step S202, the control unit 148 activates the occupant-capture unit 140 for capturing the driver information. For instance, the control unit 148 activates the interior camera 138 for capturing the driver image. From the captured driver information, the occupant-capture unit 140 generates the driver data and communicates them to the control unit 148. In step S204, the control unit 148 activates the environment-capture unit 146 for capturing the external warning signal and for generating the warning-signal data. For instance, the control unit 148 activates the microphone 142 for capturing the audio recording that includes the acoustic component of the external warning signal. In particular, the control unit 148 can also control the environment-capture unit 146 in such a manner that the environment-capture unit 146 captures the direction of the source of the warning signal relative to the vehicle 102, and generates the directional data corresponding to the direction.

In step S206, the control unit 148 ascertains, on the basis of the driver data, whether the vehicle driver 104 is temporarily restricted in his/her auditory capability. For instance, the control unit 148 ascertains, on the basis of the driver-image data, whether the vehicle driver 104 in the driver image is wearing the headphones 122 or similar accessories that restrict the acoustic perception of the vehicle driver 104. If the control unit 148 has ascertained that the vehicle driver 104 is temporarily restricted in his/her auditory capability, in step S208 the control unit 148 controls the output unit for outputting the internal warning signal. The control unit 148 controls the output unit in such a manner that the internal warning signal is perceptible by at least one sense of the vehicle driver 104. For instance, the acoustic external warning signal is output as the internal warning signal to the vehicle driver 104 as a visual output by at least one of the indicating elements 110, 112, 114. Alternatively or additionally, the internal warning signal may also have an acoustic component which, for instance, includes an audio recording of the external warning signal and which, for instance, is output via the loudspeaker 118 and/or via the headphones 122 of the vehicle driver 104. Furthermore, the internal warning signal may likewise have a haptic component which is output to the vehicle driver 104, for instance via one of the vibration functions 108, 128. The internal warning signal is output in such a manner that the internal warning signal corresponds in its warning function to the external warning signal. As visual component of the internal warning signal, a warning message in text form or as a pictogram can, for instance, be output by at least one of the indicating elements 110, 112, 114. Furthermore, the output of the internal warning signal can be undertaken from a location in the cockpit 100 that corresponds to the direction of the source of the external warning signal relative to the vehicle 102. If the source of the external warning signal is located, for example, behind the vehicle, the output of the internal warning signal can be undertaken by a functional unit of the output unit arranged, for instance, behind the driver, in particular by a loudspeaker which is arranged behind the driver, or by a vibration function 128 in the rear region of the driver's seat 106. After the output of the internal warning signal has been undertaken, the method is concluded in step S210.

In the exemplary embodiment described with reference to FIGS. 1 and 2, at least the occupant-capture unit 140, the environment-capture unit 146, the output unit and the control unit 148 constitute the device for operating the vehicle 102. Further elements and features shown in FIGS. 1 and 2 and mentioned in the preceding description may be part of the device for operating the vehicle 102.

Similarly, method steps described with reference to the device may be part of the claimed method.

### LIST OF REFERENCE SYMBOLS

100 cockpit
102 vehicle
104 vehicle driver
106 driver's seat
108 vibration function
110 central information display
112 head-up display
114 graphical instrument cluster
116 dashboard
118 loudspeaker
120 smart device
122 headphones
124 steering wheel
126 cluster
128 vibration function
130 gear selector switch
132 set of pedals
134 input unit
136 windshield
138 interior camera
140 occupant-capture unit
142 microphone
144 exterior camera
146 environment-capture unit
148 control unit
150 data output
152 data input
154 communications interface

1.-13. (canceled)

14. A device for operating a vehicle, comprising:
an occupant-capture unit of the vehicle, configured to capture at least one item of driver information relating to a vehicle driver, and to generate driver data corresponding to the driver information,
an environment-capture unit of the vehicle, configured to capture an external warning signal that has been output in an environment of the vehicle, and to generate warning-signal data corresponding to the warning signal,
an output unit configured to output an internal warning signal to the vehicle driver, and
a control unit configured to determine, based at least in part on the driver data, whether the vehicle driver is temporarily restricted in an auditory capability, and to control, based at least in part on the warning-signal data, the output unit for outputting the internal warning signal in such a manner that the internal warning signal corresponds in its warning function to the external warning signal and is perceptible by at least one sense of the vehicle driver if the control unit has determined that the vehicle driver is temporarily restricted in the auditory capability.

15. The device as claimed in claim 14, wherein:
the occupant-capture unit includes an image-capture unit of the vehicle, configured to capture at least one driver image including a representation of the vehicle driver as the driver information, and to generate driver-image data corresponding to the driver image; and
the driver data include the driver-image data, and the control unit is configured to determine, taking the driver-image data into account, whether the vehicle driver is temporarily restricted in the auditory capability.

16. The device as claimed in claim 15, wherein the control unit is configured to:
determine, based at least in part on the driver-image data, whether the vehicle driver is wearing headphones and/or noise-suppressing devices; and determine that the vehicle driver is temporarily restricted in the auditory capability if the control unit has determined that the vehicle driver is wearing headphones or noise-suppressing devices.

17. The device as claimed in claim 16, wherein the control unit is configured to:
if the vehicle driver is determined to be wearing headphones, determine whether the headphones are connected to an entertainment system of the vehicle; and
control the output unit such that the internal warning signal is output via the headphones if the control unit has determined that the headphones are connected to the entertainment system of the vehicle.

18. The device as claimed in claim 15, wherein:
the control unit includes at least one memory element and is configured to store a profile individually assigned to the vehicle driver in the memory element, and is configured to read said profile from the memory element;
the profile includes information as to whether the vehicle driver wears a hearing-aid; and
the control unit is further configured to determine, based at least in part on the driver-image data, whether the vehicle driver is currently wearing a hearing-aid, and to determine that the vehicle driver is temporarily restricted in the auditory capability if the vehicle driver is not currently wearing the hearing-aid.

19. The device as claimed in claim 14, wherein:
the occupant-capture unit is configured to determine a loudness at which media data are being played back in a vehicle interior as the driver information, and to generate loudness data corresponding to the loudness; and
wherein the driver data include the loudness data, and the control unit is configured to determine, taking the loudness data into account, whether the vehicle driver is temporarily restricted in the auditory capability.

20. The device as claimed in claim 19, wherein:
the occupant-capture unit is configured to determine whether media data are being played back to the vehicle driver by a smart device which has been brought into the vehicle interior, and to generate smart-device data corresponding to the determination that media data are being played back to the vehicle driver by the smart device; and
the driver data include the smart-device data, and the control unit is configured to determine, taking the smart-device data into account, whether the vehicle driver is temporarily restricted in the auditory capability.

21. The device as claimed in claim 14, wherein:
the occupant-capture unit is configured to determine whether media data are being played back to the vehicle driver by a smart device which has been brought into a vehicle interior, and to generate smart-device data corresponding to the determination that media data are being played back to the vehicle driver by the smart device; and
the driver data include the smart-device data, and the control unit is configured to determine, taking the smart-device data into account, whether the vehicle driver is temporarily restricted in the auditory capability.

22. The device as claimed in claim 21, wherein the output unit is configured to output the internal warning signal via the smart device.

23. The device as claimed in claim 22, wherein the output unit is configured to output the internal warning signal via headphones connected to the smart device.

24. The device as claimed in claim 14, wherein the control unit is configured to determine, based at least in part on the driver data, whether the vehicle driver is reacting to the external warning signal, and to determine that the vehicle driver is temporarily restricted in the auditory capability if the control unit has determined that the vehicle driver is not reacting to the external warning signal.

25. The device as claimed in claim 14, wherein:
the environment-capture unit includes a microphone configured to capture at least one audio recording of the environment of the vehicle, and to generate audio data corresponding to the audio recording;
the warning-signal data include the audio data; and
the control unit is configured to control, based at least in part on the audio data, the output unit for outputting the internal warning signal in such a manner that the internal warning signal corresponds in a warning function to the external warning signal.

26. The device as claimed in claim 25, wherein:
the occupant-capture unit includes an image-capture unit of the vehicle, configured to capture at least one driver image including a representation of the vehicle driver as the driver information, and to generate driver-image data corresponding to the driver image; and
the driver data include the driver-image data, and the control unit is configured to determine, taking the driver-image data into account, whether the vehicle driver is temporarily restricted in the auditory capability.

27. The device as claimed in claim 25, wherein:
the occupant-capture unit is configured to determine a loudness at which media data are being played back in a vehicle interior as the driver information, and to generate loudness data corresponding to the loudness; and
wherein the driver data include the loudness data, and the control unit is configured to determine, taking the loudness data into account, whether the vehicle driver is temporarily restricted in the auditory capability.

28. The device as claimed in claim 14, wherein:
the environment-capture unit includes an image-capture unit of the vehicle, configured to capture at least one exterior image including a representation of the environment of the vehicle, and to generate exterior-image data corresponding to the exterior image; and
the warning-signal data include the exterior-image data, and the control unit is configured to control, based at least in part on the exterior-image data, the output unit for outputting the internal warning signal such that the internal warning signal corresponds in its warning function to the external warning signal.

29. The device as claimed in claim 14, wherein:
the environment-capture unit is configured to capture a direction from which the external warning signal is being output, and to generate directional data corresponding to the direction;
the warning-signal data include the directional data; and
the control unit is configured to control the output unit for outputting the internal warning signal such that the warning signal is output at a location within a vehicle interior that corresponds to the direction from which the external warning signal is being output.

30. A method for operating a vehicle,
capturing at least one item of driver information relating to a driver of the vehicle, and generating driver data corresponding to the driver information;
capturing an external warning signal that has been output in an environment of the vehicle, and generating warning-signal data corresponding to the warning signal;
determining, based at least in part on the driver data, whether the vehicle driver is temporarily restricted in an auditory capability; and
based at least in part on the warning-signal data, outputting an internal warning signal to the vehicle driver in such a manner that the internal warning signal corresponds in its warning function to the external warning signal and is perceptible by at least one sense of the vehicle driver if it has been determined that the vehicle driver is temporarily restricted in the auditory capability.

31. The method of claim 30 wherein, for operating a vehicle, wherein capturing at least one item of driver information includes using a camera mounted on the vehicle to capture the at least one item of driver information.

32. A method of claim 31, wherein for operating a vehicle, wherein outputting the internal warning signal includes output the internal warning signal via a smart device brought into the vehicle or via an entertainment system of the vehicle.

33. A device for operating a vehicle, comprising:
at least a first sensor of the vehicle, configured to at least in part capture at least one item of driver information relating to a vehicle driver, and to generate driver data corresponding to the driver information,
at least a second sensor of the vehicle, configured to at least in part capture an external warning signal that has been output in an environment of the vehicle, and to generate warning-signal data corresponding to the warning signal,
an output configured to output an internal warning signal to the vehicle driver, and
a control unit configured to determine, based at least in part on the driver data, whether the vehicle driver is temporarily restricted in an auditory capability, and to control, based at least in part on the warning-signal data, the output unit for outputting the internal warning signal in such a manner that the internal warning signal corresponds in its warning function to the external warning signal and is perceptible by at least one sense of the vehicle driver if the control unit has determined that the vehicle driver is temporarily restricted in the auditory capability.
